(19) United States
(12) Patent Application Publication
(10) Pub. No.: US 2009/0262168 A1
(43) Pub. Date: Oct. 22, 2009

(54) LIQUID EJECTING HEAD AND LIQUID EJECTING APPARATUS

(75) Inventor: Akiko Okamura, Matsumoto-Shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/410,402

(22) Filed: Mar. 24, 2009

(30) Foreign Application Priority Data
Mar. 25, 2008 (JP) 2008-077461
Dec. 25, 2008 (JP) 2008-329366

(51) Int. Cl. B41J 2/045

(52) U.S. Cl. 347/68

(57) ABSTRACT

A liquid ejecting head includes a flow path substrate that has an array of pressure generating chambers communicating with nozzle openings, respectively, piezoelectric elements arranged in a region corresponding to the pressure generating chambers, a driver IC driving the piezoelectric elements, an array of individual lead electrodes extending in the same direction from individual electrodes of the piezoelectric elements, connection portions, disposed in the respective individual lead electrodes, for electrical connection to the driver IC, and inspection regions arranged in the individual lead electrodes.

This application claims priority to Japanese Patent Application No. 2008-077461, filed Mar. 25, 2008 and Japanese Patent Application No. 2008-329366, filed Dec. 25, 2008, the entirety of each of the aforementioned applications are expressly incorporated by reference herein.

### BACKGROUND

1. Technical Field

The present invention relates to a liquid ejecting head and a liquid ejecting apparatus. In particular, the invention relates to an ink jet recording head in which a diaphragm constitutes part of a pressure generating chamber communicating with a nozzle opening through which ink droplets are ejected, a piezoelectric element is placed on one surface of the diaphragm, and the ink droplets are ejected by deflection of the piezoelectric element, and relates to an ink jet recording apparatus including the ink jet recording head.

2. Related Art

As one of known structures of ink jet recording heads, an ink jet recording head includes a flow path substrate which has an array of pressure generating chambers communicating with respective nozzle openings and an opposite substrate which is joined to one surface, where piezoelectric elements are arranged, of the flow path substrate and on which a driver integrated circuit (IC) driving the piezoelectric elements is mounted.

A known piezoelectric element includes an upper electrode layer, a piezoelectric layer, and a lower electrode layer. Any one of the upper and lower electrode layers of each piezoelectric element serves as a common electrode. A common lead electrode extends from the common electrode. The other electrode functions as an individual electrode. An individual lead electrode extends from each individual electrode. The driver IC is connected to a connection portion provided for each individual lead electrode through a connection line (refer to PCT Publication No. WO 2003-78167 (FIG. 3)).

In the ink jet recording head, for example, the pitch between piezoelectric elements tends to be reduced in order to increase the quality of an image formed by ejected ink. In the case where the individual lead electrodes extend in the same direction to form an array, therefore, the width of each individual lead electrode is also reduced.

Before the individual lead electrodes are connected to the driver IC through the respective connection lines, the driving characteristics of the piezoelectric elements are inspected. The inspection is performed on the piezoelectric elements to be actually used by bringing inspection probes into contact with the common electrode and the individual lead electrodes. Accordingly, if any individual lead electrode having a narrow width is damaged by the inspection probe, a break easily occurs in the individual lead electrode.

Such a problem exists not only in the ink jet recording heads ejecting ink droplets but also in other liquid ejecting heads ejecting droplets of liquid other than ink.

### SUMMARY

An advantage of some aspects of the invention is to solve at least part of the above-described problem.

According to an aspect of the invention, a liquid ejecting head includes a flow path substrate that has an array of pressure generating chambers communicating with nozzle openings, respectively, piezoelectric elements arranged in a region corresponding to the pressure generating chambers, a driver IC driving the piezoelectric elements, an array of individual lead electrodes extending in the same direction from individual electrodes of the piezoelectric elements, connection portions, disposed in the respective individual lead electrodes, for electrical connection to the driver IC, and inspection regions arranged in the individual lead electrodes.

According to this aspect, since the inspection regions are arranged in the individual lead electrodes, an inspection probe can be brought into contact with each inspection region to perform inspection. Advantageously, the liquid ejecting head in which a break in the individual lead electrodes is reduced is obtained.

Preferably, the individual lead electrodes are wiring lines made of a conductive layer placed on the flow path substrate, and the inspection regions are regions in each of which the width of the wiring line is larger than that in the other region.

In this case, since the individual lead electrodes are made of the conductive layer, the wiring lines and the inspection regions whose width is larger than that of the other region in the wiring line are easily formed as a pattern by etching. In addition, if an inspection probe is hit against any inspection region, a conducting region can be ensured because the width of the inspection region is larger than that of the other region in the wiring line. The liquid ejecting head in which a break in the individual lead electrodes is further reduced is obtained.

Preferably, each inspection region is located closer to the outer end of the extending individual lead electrode than the connection portion.

In this case, each inspection region is closer to the outer end of the individual lead electrode than the connection portion. Accordingly, if the entire inspection region is damaged, the conductivity between the connection portion and the individual electrode of the piezoelectric element is slightly affected by the damage. Advantageously, the liquid ejecting head in which a break in the individual lead electrodes is further reduced is obtained.

Preferably, the individual lead electrodes include first lead electrodes and second lead electrodes, each first lead electrode is shorter than each second lead electrode, and each inspection region is located in an area where the first lead electrode is not formed.

In this case, each inspection region can have a large area since at least one of the individual lead electrodes next to each individual lead electrode having the inspection region is placed as a first lead electrode avoiding the inspection region. If an inspection probe is hit against any inspection region and the region is damaged, a wide conducting region can be ensured. Advantageously, the ink jet recording head in which a break in the second lead electrodes is further reduced is obtained.

Preferably, at least one of the individual lead electrodes next to each individual lead electrode having the inspection region is provided with a detour portion that avoids the inspection region.

In this case, at least one of the individual lead electrodes next to each individual lead electrode having the inspection region is provided with the detour portion that avoids the inspection region, the inspection region can be increased. If an inspection probe is hit against the inspection region and the region is damaged, a greater conducting region is ensured. Advantageously, the liquid ejecting head in which a break in the individual lead electrodes is further reduced is obtained.

According to another aspect of the invention, a liquid ejecting apparatus includes the liquid ejecting head according to the above-described aspect.

According to this aspect, the reliable liquid ejecting apparatus with the above-described liquid ejecting head can be achieved.

### BRIEF DESCRIPTION OF THE DRAWINGS

The invention will be described with reference to the accompanying drawings, wherein like numbers reference like elements.

FIG. 1 is an exploded perspective view of an ink jet recording head according to a first embodiment of the invention.

FIG. 2A is a plan view of part of the ink jet recording head.

FIG. 2B is a cross-sectional view taken along the line IIB-IIB in FIG. 2A.

FIG. 3 is a plan view of part of an ink jet recording head according to a second embodiment.

FIG. 4 is a plan view of part of an ink jet recording head according to a third embodiment.

FIG. 5 is a plan view of part of an ink jet recording head according to a fourth embodiment.

FIG. 6 is a schematic diagram illustrating an example of an ink jet recording apparatus.

### DESCRIPTION OF EXEMPLARY EMBODIMENTS

Embodiments of the invention will be described in detail below with reference to the drawings.

### First Embodiment

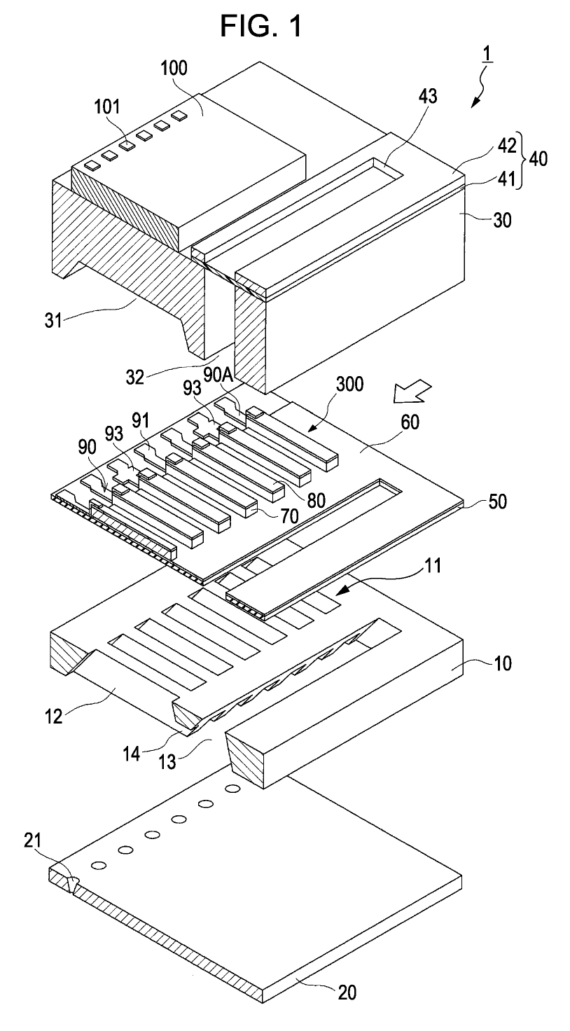

FIG. 1 is an exploded perspective view of an ink jet recording head 1 serving as a liquid ejecting head according to a first embodiment of the invention. The ink jet recording head 1 has a substantially rectangular parallelepiped shape. FIG. 1 also illustrates a cross section of the ink jet recording head 1 taken along the plane orthogonal to the lengthwise direction, indicated by the open arrow in the figure, of the ink jet recording head 1.

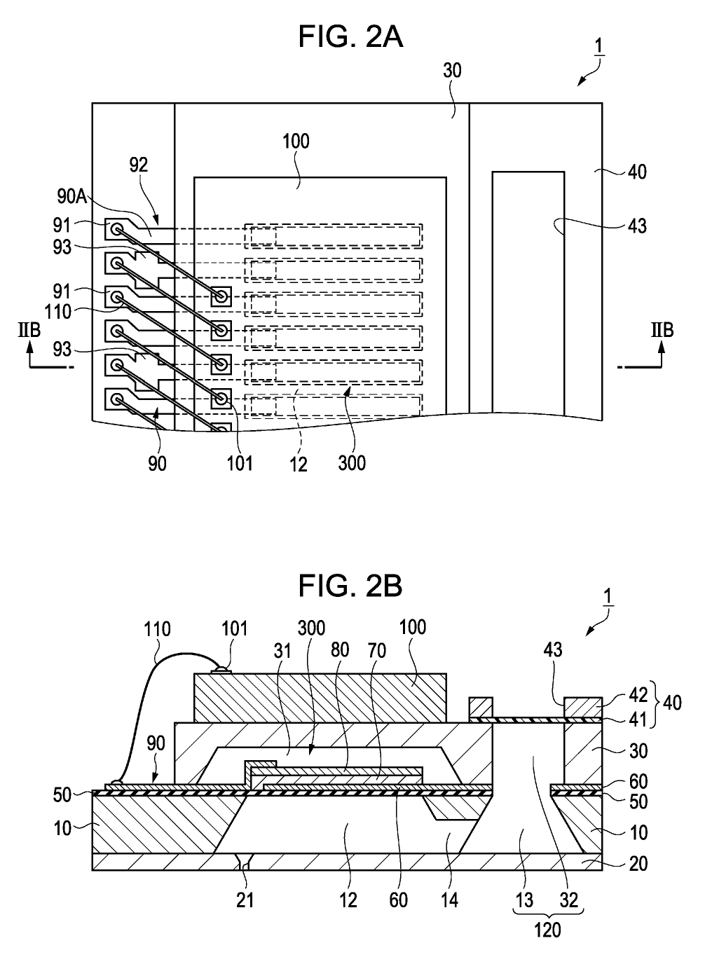

FIG. 2A is a plan view of part of the ink jet recording head 1 and FIG. 2B is a cross-sectional view taken along the line IIB-IIB in FIG. 2A.

Referring to FIGS. 1 to 2B, the ink jet recording head 1 includes a flow path substrate 10, a nozzle plate 20, an opposite substrate 30 which is joined to the substrate 10, a compliance substrate 40, and a driver IC 100.

The flow path substrate 10, the nozzle plate 20, and the opposite substrate 30 are stacked such that the flow path substrate 10 is interposed between the nozzle plate 20 and the opposite substrate 30. The opposite substrate 30 is overlaid with the compliance substrate 40. The driver IC 100 is mounted on the compliance substrate 40.

The flow path substrate 10 is made of a (110) single-crystalline silicon plate. In the flow path substrate 10, a plurality of pressure generating chambers 12 are formed by anisotropic etching so as to form an array 11 of chambers. Each pressure generating chamber 12 has a trapezoidal cross section taken along the plane perpendicular to the lengthwise direction of the ink jet recording head 1. The pressure generating chamber 12 extends in the widthwise direction of the ink jet recording head 1.

An ink supply path 13 is placed adjacent to one end of each pressure generating chamber 12 parallel to the widthwise direction of the chamber in the flow path substrate 10. The ink supply path 13 communicates with each pressure generating chamber 12 through a communication port provided for the pressure generating chamber 12. The width of the communication port 14 is smaller than that of the pressure generating chamber 12 so that a resistance in the flow path of ink flowing through the communication port into the pressure generating chamber 12 is held constant.

The nozzle plate 20 has nozzle openings 21 located in the vicinities of the other ends of the pressure generating chambers 12 remote from the ink supply path 13. The nozzle openings 21 communicate with the pressure generating chambers 12, respectively.

The flow path substrate 10 is bonded to the nozzle plate 20 with adhesive or a thermal welding film.

On the surface of the flow path substrate 10 facing away from the nozzle plate 20, an elastic membrane 50 as a diaphragm is disposed. The elastic membrane 50 is made of an oxidation film formed by thermal oxidation.

The elastic membrane 50 on the flow path substrate is overlaid with a lower electrode layer 60, a piezoelectric layer 70, and an upper electrode layer 80 which constitute piezoelectric elements 300. The lower electrode layer 60 is made of metal, such as platinum (Pt), or metal oxide, such as strontium ruthenium oxide (SrRuO). The piezoelectric layer 70 has a perovskite structure. The upper electrode layer 80 is made of metal, such as gold (Au) or iridium (Ir). In this instance, each piezoelectric element 300 is a portion including the lower electrode layer 60, the piezoelectric layer 70, and the upper electrode layer 80.

As for a material for the piezoelectric layer 70, a ferroelectric piezoelectric material, such as lead zirconate titanate (PZT), or a relaxer ferroelectric substance obtained by adding a metal, such as niobium, nickel, magnesium, bismuth, or yttrium, to a ferroelectric piezoelectric material is used. The composition of the material may be appropriately determined in consideration of the characteristics and application of the piezoelectric elements 300.

Typically, either of the electrodes of each piezoelectric element 300 is formed as a common electrode and the other electrode thereof is formed by patterning for each pressure generating chamber 12. In this embodiment, the piezoelectric element 300 includes the patterned electrode and the piezoelectric layer 70. Upon application of voltage to the two electrodes of the piezoelectric element 300, piezoelectric strain is caused.

In this embodiment, the lower electrode layer 60 serves as the common electrode of the piezoelectric elements 300 and the upper electrode layer 80 includes the individual electrodes thereof. The relationship therebetween may be inverted for convenience of a driving circuit or wiring.

The lower electrode layer 60 is placed over a region corresponding to the pressure generating chambers 12 so as to extend outwardly from a region corresponding to the array 11 of the pressure generating chambers 12.

Referring to FIGS. 1 to 2A, individual lead electrodes 90, serving as wiring lines including a conductive layer made of, for example, gold (Au), are connected to segments of the upper electrode layer 80 (hereinafter, also referred to as “upper electrode layer segments 80”) constituting the piezoelectric elements 300, respectively.

Each individual lead electrode 90 includes a strip body 90A and a connection portion 91 in the outer end of the strip body 90A. Some of the individual lead electrodes 90 each have an inspection region 93. The individual lead electrodes 90 extend in the same direction, thus forming an array 92 of electrodes.

The connection portion 91 is located in the outer end of the individual lead electrode 90 in the extending direction, in which the individual lead electrode 90 extends, such that at least one side face of the connection portion 91 perpendicular to the widthwise direction thereof protrudes from the body 90A.

Although one inspection region 93 is provided every two individual lead electrodes 90, the arrangement of the inspection regions 93 can be appropriately changed. For example, one inspection region 93 may be provided for each individual lead electrode 90 or one individual lead electrode 90 having the inspection region 93 may be provided every three or more individual lead electrodes 90. The width of each inspection region 93 is larger than that of the other region in the body 90A. The inspection region 93 is shaped in a substantially rectangular form. So long as the width of the inspection region 93 is larger than that of the other region in the body 90A, the inspection region 93 may have any shape, e.g., a circular form other than the rectangular form.

The individual lead electrodes 90 can be formed by photolithography so as to have any planar shape.

The flow path substrate 10, on which the piezoelectric elements 300 are arranged, is joined to the opposite substrate 30 on which the driver IC 100 for driving the piezoelectric elements 300 is mounted.

The opposite substrate 30 has a piezoelectric-element holding portion 31 in a region facing the piezoelectric elements 300 so as to provide a space in which the motion of each piezoelectric element 300 is not hindered. The piezoelectric-element holding portion 31 is provided so as to correspond to the array 11 of the pressure generating chambers 12.

In this embodiment, the piezoelectric-element holding portion 31 is incorporated in the opposite substrate 30 so as to correspond to the array 11 of the pressure generating chambers 12. Individual piezoelectric-element holding portions 31 may be provided so as to correspond to the piezoelectric elements 300, respectively. As for a material for the opposite substrate 30, glass, a ceramic material, metal, or resin is used. More preferably, the opposite substrate 30 is made of a material having substantially the same coefficient of thermal expansion as that of the material for the flow path substrate 10. In this embodiment, the opposite substrate 30 is made of a single-crystalline silicon plate that is the same material as that for the flow path substrate 10.

The opposite substrate 30 has a reservoir portion 32 in a region corresponding to the ink supply path 13 in the flow path substrate 10. In this embodiment, the reservoir portion 32 is located along the array 11 of the pressure generating chambers 12 so as to extend through the opposite substrate 30 in the thicknesswise direction thereof. The reservoir portion 32 communicates with the ink supply path 13 in the flow path substrate 10 to constitute a reservoir 120, serving as an ink chamber common to the pressure generating chambers 12.

The opposite substrate 30 has thereon a wiring pattern to which external wiring lines (not shown) are connected and which receives driving signals supplied through the lines. The driver IC 100, serving as a semiconductor integrated circuit (IC) for driving the piezoelectric elements 300, is mounted on the wiring pattern.

The driving signals include a driving signal for driving the driver IC, e.g., a driving power signal, and various control signals, e.g., serial signals (SI). The wiring pattern includes a plurality of wiring lines to which signals are supplied.

Pads 101 of the driver IC 100 are electrically connected to the connection portions 91 of the individual lead electrodes 90 extending from the respective piezoelectric elements 300 through connection lines 110 including conductive wires, e.g., bonding wires. Similarly, the driver IC 100 is electrically connected to the lower electrode layer 60 through a connection line (not shown).

Furthermore, the opposite substrate 30 is joined to the compliance substrate 40 including a sealing layer 41 and a fixing plate 42. The sealing layer 41 is made of a low-rigidity, or flexible material (for example, a polyphenylene sulfide (PPS) film having a 6 μm thickness). One face of the reservoir portion 32 is sealed with the sealing layer 41. The fixing plate 42 is made of a rigid material, e.g., metal (for example, stainless steel (SUS) having a 30 μm thickness). The fixing plate 42 has an opening 43 formed by completely removing the plate in a region corresponding to the reservoir 120. Accordingly, the one face of the reservoir 120 includes only the flexible sealing layer 41.

This embodiment has the following advantages.

(1) Since the individual lead electrodes 90 are provided with the inspection regions 93, an inspection probe can be brought into contact with each inspection region 93 to perform inspection. Thus, the ink jet recording head 1 in which a break in the individual lead electrodes 90 is reduced can be obtained.

(2) Since the individual lead electrodes 90 are made of the conductive layer, the individual lead electrodes 90 and the inspection regions 93, whose width is larger than that of the other region in the individual lead electrode 90, can be easily formed as a pattern by etching. In addition, if an inspection probe is hit against any inspection region 93 and the region is damaged, a conducting region can be ensured because the width of each inspection region 93 is larger than that of the other portion in the individual lead electrode 90. Advantageously, the ink jet recording head 1 in which a break in the individual lead electrodes 90 is further reduced can be obtained.

### Second Embodiment

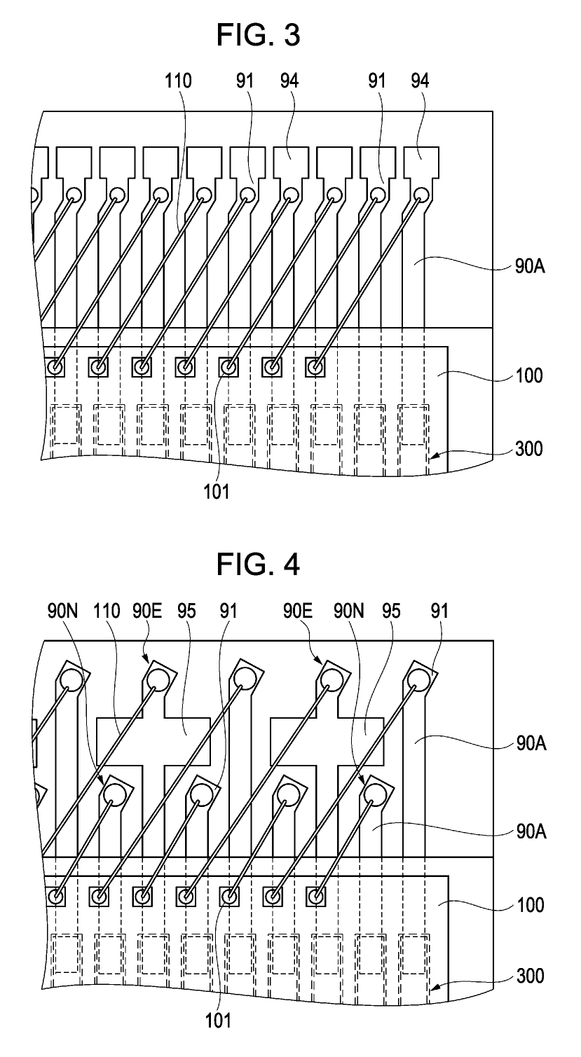

FIG. 3 is a plan view of part of an ink jet recording head according to a second embodiment of the invention. The same components as those of the first embodiment are designated by the same reference numerals and redundant description is avoided.

The second embodiment differs from the first embodiment in that an inspection region 94 is located closer to the outer end of each individual lead electrode 90 in the extending direction than the connection portion 91.

Specifically, the rectangular inspection region 94 is placed in the outer end of each individual lead electrode 90 such that the region 94 is located in the vicinity of the electrical connection portion 91. In this embodiment, all of the individual lead electrodes 90 have the inspection regions 94, respectively.

The second embodiment has the following advantage.

(3) Each inspection region 94 is located closer to the outer end of the individual lead electrode 90 than the connection portion 91. Accordingly, if the entire inspection region 94 is damaged, the conductivity between the connection portion 91 and the upper electrode layer segment 80 of the piezoelectric element 300 is not affected by the damage. Thus, the ink jet recording head 1 in which a break in the individual lead electrodes 90 is further reduced can be obtained.

### Third Embodiment

FIG. 4 is a plan view of part of an ink jet recording head according to a third embodiment of the invention. In the following description, the same components as those of the first embodiment are designated by the same reference numerals and redundant description is avoided.

In this embodiment, an individual lead electrode 90N next to each individual lead electrode 90E having an inspection region 95 is short. Therefore, a space is formed on each side of the long extending individual lead electrode 90E in the widthwise direction thereof. The inspection region 95 is formed so as to have a large area in this space. In other words, the inspection region 95 is disposed in the widthwise direction of the individual lead electrode 90E (second lead electrode) longer than the individual lead electrode 90N (first lead electrode) such that the inspection region 95 is located in a region where the individual lead electrode 90N is not provided.

This embodiment has the following advantage.

(4) Each inspection region 95 can have a large area since at least one of the individual lead electrodes next to each individual lead electrode 90E having the inspection region 95 is placed as an individual lead electrode 90N avoiding the inspection region 95. If an inspection probe is hit against any inspection region 95 and the region is damaged, a wide conducting region can be ensured. Thus, the ink jet recording head 1 in which a break in the individual lead electrodes 90E is further reduce can be obtained.

### Fourth Embodiment

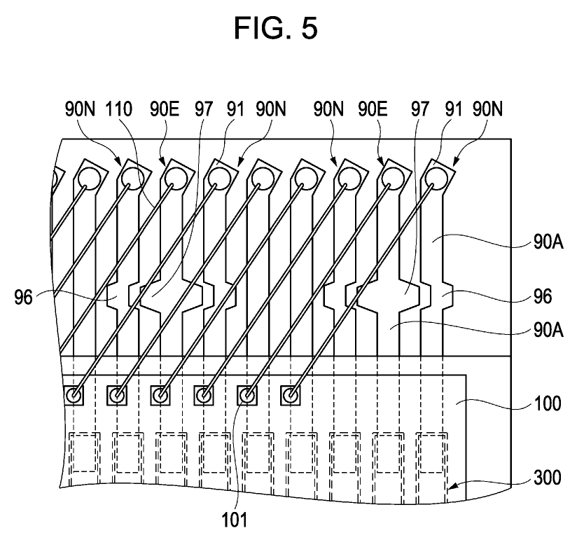

FIG. 5 is a plan view of part of an ink jet recording head according to a fourth embodiment of the invention. In the following description, the same components as those of the first embodiment are designated by the same reference numerals and redundant description is avoided.

Each individual lead electrode 90N next to an individual lead electrode 90E having an inspection region 97 is provided with a detour portion 96 so as to avoid the inspection region 97.

This embodiment has the same advantage as that of the third embodiment.

Various modifications can be made in addition to the above-described embodiments.

For example, each inspection region is not a two-dimensional area. The inspection region may be a portion protruding from the individual lead electrode 90 away from the flow path substrate 10. Specifically, a protrusion may be provided for the individual lead electrode 90. In this case, if the top of the protrusion, serving as the inspection region, is damaged, the base of the protrusion is ensured as a conducting region. Thus, the ink jet recording head 1 in which a break in the individual lead electrodes 90 is further reduced can be obtained.

In addition, one inspection region may be provided for each individual lead electrode. Alternatively, one individual lead electrode having the inspection region may be disposed every two or more individual lead electrodes. It is preferable that the individual lead electrode extending from the piezoelectric element 300 corresponding to the pressure generating chamber 12 located at each end of the array be not used for inspection, since the thickness of one side wall of the pressure generating chamber 12 is not different from those of the other pressure generating chambers 12 and the driving characteristics of the corresponding piezoelectric element 300 are different from those of the other piezoelectric elements 300.

When the inspection region is provided for an individual lead electrode in the vicinity of each end of the array of the individual lead electrodes, the driving characteristics of each of the piezoelectric elements 300 located between the individual lead electrodes each having the inspection region can be predicted. In addition, the larger the number of inspection regions, the higher the predictive accuracy.

The shape of the connection portion 91 is not limited to the shape in each embodiment in which at least one side face of the connection portion 91 perpendicular to the widthwise direction thereof protrudes from the body 90A. The connection portion 91 may be a strip portion extending straight from the body 90A. In addition, the combination of the foregoing embodiments may be used. For example, the positions and sizes of the inspection regions 93, 94, 95, and 97 in the respective embodiments and the individual lead electrode 90N having the detour portion 96 may be combined so that a large inspection region is provided.

In the above-described embodiments, the opposite substrate 30 having the piezoelectric-element holding portion 31 has been described as an example of a substrate bonded to the flow path substrate 10. So long as the opposite substrate is mounted with the driver IC, any substrate may be used.

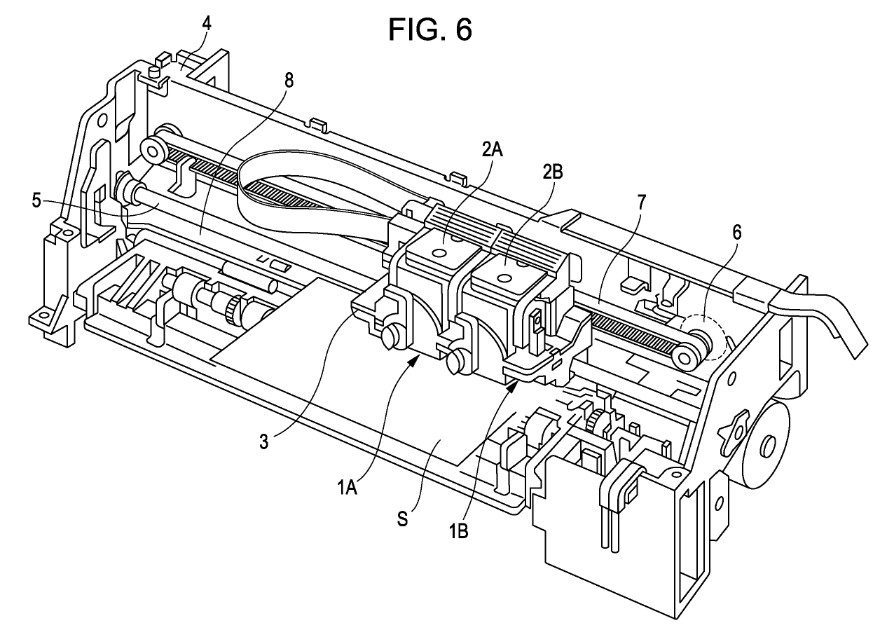

The ink jet recording head according to each of the embodiments constitutes a recording head unit provided with an ink flow path communicating with an ink cartridge and is mounted on an ink jet recording apparatus, serving as an example of a liquid ejecting apparatus. FIG. 6 is a schematic diagram illustrating the ink jet recording apparatus. Referring to FIG. 6, recording head units 1A and 1B are provided with detachable cartridges 2A and 2B, respectively. The recording head units 1A and 1B each have the above-described ink jet recording head. The cartridges 2A and 2B each function as an ink supplier. A carriage 3 mounted with the recording head units 1A and 1B is attached to a carriage shaft 5 fixed to an apparatus body 4 such that the carriage 3 is movable along the carriage shaft 5. The recording head units 1A and 1B discharge, for example, a black ink composition and a color ink composition, respectively. A driving force produced by a driving motor 6 is transferred to the carriage 3 through a plurality of gears (not shown) and a timing belt 7, so that the carriage 3 mounted with the recording head units 1A and 1B is moved along the carriage shaft 5. The apparatus body 4 is provided with a platen 8 extending along the carriage shaft 5 so that a recording sheet S, serving as a recording medium, e.g., a sheet of paper, fed by a paper feed roller (not illustrated) is transported on the platen 8.

Although FIG. 6 illustrates the ink jet recording apparatus as an example of a serial type liquid ejecting apparatus, the invention can also be applied to an ink jet recording apparatus (line printer) as an example of a line-head liquid ejecting apparatus.

Although the ink jet recording head has been described as an example of the liquid ejecting head according to the invention in the above-described embodiments, the fundamental structure of the liquid ejecting head is not limited to any above-described structure. Since the invention is intended for all of general liquid ejecting heads, the invention is applicable to other heads ejecting liquid other than ink. The other liquid ejecting heads include various recording heads used in an image recording apparatus, such as a printer, a color material ejecting head used for manufacture of color filters in a liquid crystal display, an electrode material ejecting head used for formation of electrodes in an organic electroluminescent (EL) display or a field emission display (FED), and an organic material ejecting head used for manufacture of biochips. A liquid ejecting apparatus mounted with a liquid ejecting head is applicable not only to the ink jet recording apparatus but also to other liquid ejecting apparatuses ejecting liquid other than ink.

What is claimed is:

1. A liquid ejecting head comprising:
a flow path substrate that has an array of pressure generating chambers communicating with nozzle openings, respectively;
piezoelectric elements arranged in a region corresponding to the pressure generating chambers;
a driver IC driving the piezoelectric elements;
an array of individual lead electrodes extending in the same direction from individual electrodes of the piezoelectric elements;
connection portions, disposed in the respective individual lead electrodes, for electrical connection to the driver IC; and
inspection regions arranged in the individual lead electrodes.

2. The liquid ejecting head according to claim 1,
wherein
the individual lead electrodes are wiring lines made of a conductive layer placed on the flow path substrate, and
the inspection regions are regions in each of which the width of the wiring line is larger than that in the other region.

3. The liquid ejecting head according to claim 1, wherein each inspection region is located closer to the outer end of the extending individual lead electrode than the connection portion.

4. The liquid ejecting head according to claim 1, wherein
the individual lead electrodes include first lead electrodes and second lead electrodes,
each first lead electrode is shorter than each second lead electrode, and
each inspection region is located in an area where the first lead electrode is not formed.

5. The liquid ejecting head according to claim 1, wherein at least one of the individual lead electrodes next to each individual lead electrode having the inspection region is provided with a detour portion that avoids the inspection region.

6. A liquid ejecting apparatus comprising the liquid ejecting head according to claim 1.
